(19) United States
(12) Patent Application Publication
(10) Pub. No.: US 2026/0245252 A1
(43) Pub. Date: Aug. 20, 2026

(54) ARRAY CAMERA FOR EXTRACTING 2D AND 3D INFORMATION OF A SCENE

(71) Applicant: NIL Technology ApS, Kongens Lyngby (DK)

(72) Inventors: Niklas Hansson, Askim (SE); Ehsan Hashemi, Stockholm (SE); Terry Merschat, Sunnyvale, CA (US)

(21) Appl. No.: 19/474,949

(22) PCT Filed: Apr. 19, 2024
(86) PCT No.: PCT/EP2024/060850

§ 371 Date: Oct. 13, 2025

Related U.S. Application Data
(60) Provisional application No. 63/497,062, filed on Apr. 19, 2023.

(51) Int. Cl. G06T 7/80; G06T 7/571; G06T 7/593

(52) U.S. Cl. CPC G06T 7/85; G06T 7/571; G06T 7/593; G06T 2207/10012; G06T 2207/20081

(57) ABSTRACT

An imaging device includes at least one sensor comprising a plurality of light sensitive regions, each region operable to capture a respective image of a scene to be imaged; a first imaging component and a second imaging component, wherein each of the first and the second imaging components are individually configured to capture images of the scene for extracting three-dimensional information of the scene, wherein the first imaging component has a first optical feature and the second imaging component has a second optical feature, wherein a difference between the first and the second optical feature is higher than a predetermined optical feature difference threshold.

### BACKGROUND

This specification relates to imaging devices such as array cameras. Array cameras can be based on arrays of lenses. The individual image produced by each lens in the array can in some cases be combined to produce an image that has higher resolution than the individual images.

### SUMMARY

This specification describes technologies relating to array cameras and in particular to array cameras that can be used to obtain two-dimensional and/or three-dimensional information (e.g., depth information) about a scene recorded in the image.

In general, one or more aspects of the subject matter described in this specification can be embodied in an imaging device including: at least one sensor including a plurality of light sensitive regions, each region operable to capture a respective image of a scene to be imaged; a first imaging component and a second imaging component. Each of the first and the second imaging components can be individually configured to capture images of the scene for extracting three-dimensional information of the scene. The first imaging component can have a first optical feature and the second imaging component can have a second optical feature, wherein a difference between the first and the second optical feature is higher than a predetermined optical feature difference threshold.

Implementations of the aspects may include one or more features. The first optical feature can be associated with a first focal length, the second optical feature can be associated with a second focal length, wherein a difference between the first and the second focal lengths is higher than a predetermined focal length difference. The first optical feature can be associated with a first f-number, the second optical feature can be associated with a second f-number, wherein a difference between the first and the second f-numbers is higher than a predetermined focal length difference.

The imaging device can include an image processor operable to receive signals representing the respective images captured by the light sensitive regions, wherein the image processor is further operable to extract three-dimensional information of the scene based on the difference between the first and the second optical feature.

In general, one or more aspects of the subject matter described in this specification can be embodied in one or more methods (and also one or more non-transitory computer-readable mediums tangibly encoding a computer program operable to cause one or more processors to perform operations), including: obtaining a comparison measure between a first image and a second image of a scene, wherein the first image is captured by a first imaging component and the second image is captured by a second imaging component. The first imaging component can have a first optical feature and the second imaging component can have a second optical feature, wherein a difference between the first and the second optical feature is higher than a predetermined optical feature difference threshold.

One or more aspects of the subject matter described in this specification can also be embodied in one or more systems including one or more processors; and a computer-readable medium storing instructions that cause the one or more processors to perform operations including: obtaining a comparison measure between a first image and a second image of a scene, wherein the first image is captured by a first imaging component and the second image is captured by a second imaging component. The first imaging component can have a first optical feature and the second imaging component can have a second optical feature, wherein a difference between the first and the second optical feature is higher than a predetermined optical feature difference threshold.

The first optical feature can be associated with a first focal length, the second optical feature can be associated with a second focal length, wherein a difference between the first and the second focal lengths is higher than a predetermined focal length difference. The first optical feature can be associated with a first f-number second optical feature can be associated with a second f-number, wherein a difference between the first and the second focal lengths is higher than a predetermined focal length difference.

Obtaining the comparison measure can include obtaining a blur amount comparison measure and/or a disparity measure. Extracting three-dimensional information from the scene based on the comparison measure can include extracting the three-dimensional information based on the blur comparison measure and/or the disparity measure.

The three-dimensional information can be extracted by a machine learning network trained to extract the three-dimensional information based on the blur comparison measure and/or the disparity measure. The machine learning network can be trained based on a deep learning algorithm.

Particular embodiments of the subject matter described in this specification can be implemented to realize one or more of the following advantages. The systems and techniques described herein can be used to provide snapshot parallel imaging systems using one-dimensional (1D) or two-dimensional (2D) arrays of optics that project light onto a sensor or an array of sensors. Postprocessing algorithms can be used to compute additional information about an imaged scene. Postprocessing can be used to add depth information to existing images (e.g., RGB images), to restore high-resolution information from low-resolution input (e.g., super-resolution, refocus, virtual viewpoint, etc.), and/or to reconstruct high dynamic range (HDR), among other applications. Further, the cost and footprint of the optics components and the computational unit can be optimized while at the same time high performance with calculation of additional features (such as depth) is achieved. Array cameras including metaoptical elements can provide several benefits in terms of reduced cost and small footprint thanks to planar wafer-level manufacturing processess. Further, each channel can be independently controlled and tailored for a different function, wavelength and/or polarization of the light. This makes metaoptical elements particularly suitable for array cameras and parallel imaging systems.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIGS. 1-3 show examples of array cameras operable to generate an image of a scene and to extract 3D information from the scene.

FIG. 4 shows an example of an array camera that incorporates folded optics and that is operable to generate an image of a scene and to extract 3D information from the scene.

FIG. 5 is a flowchart of an example of a method of operation of the imaging devices of any one of FIGS. 1-3.

FIG. 6 is a schematic diagram of a data processing system including a data processing apparatus, which can be programmed as a client or as a server, and implement techniques described in this document.

Like reference numbers and designations in the various drawings indicate like elements.

### DETAILED DESCRIPTION

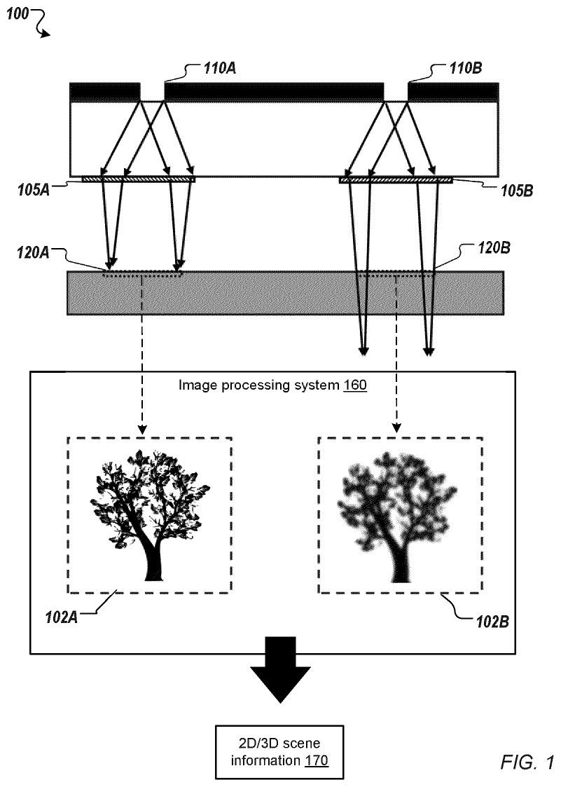

FIGS. 1-3 show examples of imaging devices operable to generate an image of a scene and to extract 3D information from the scene. FIG. 1 shows an example of an imaging device 100 (e.g., an array camera) including two imaging components such as metalenses 105A and 105B with respective apertures 110A and 110B that can direct light to light-sensitive portions 120A, 120B of an imaging sensor to capture respective images 102A, 102B. Lenses 105A and 105B can have different optical features. In the example of FIG. 1, lenses 105A and 105B have different focal lengths. For example, a difference in the focal lengths of lenses 105A and 105B can be higher than a predetermined threshold. The resulting difference in optical feature enables the extraction of 2D and 3D information 170. Lenses 105A, 105B can be designed such that one of the lenses provides a sharper 2D image than the other. For example, at least one of the lenses (e.g., lens 105A) provides a sharp 2D image. In the example of FIG. 1, the focal length of lens 105A matches the distance to its corresponding light-sensitive portion 120A and produces a sharp image 102A. In the example of FIG. 1, the focal length of lens 105B does not match the distance to its corresponding light-sensitive portion 120B and produces a blurry image 102B. For example, 3D information can be extracted by an image processing system 160 from the fact that objects at different distance from a lens are captured with different blur amounts in the image. In operation, a comparison measure based on an amount of blur in images 102A and 102B captured with lenses 105A and 105B can be used to extract the 3D information.

Additionally or alternatively, the disparity (e.g., angular disparity) caused by the different locations of lenses 120A and 102B can also be used by imaging processing system 160 to extract 3D information. The resulting 3D information can be used for applications such as eye tracking and face identification. In some examples, additional imaging components with respective additional lenses having focal lengths with values between the lowest focal length and the highest focal length of the array camera can be added in order to improve the depth map.

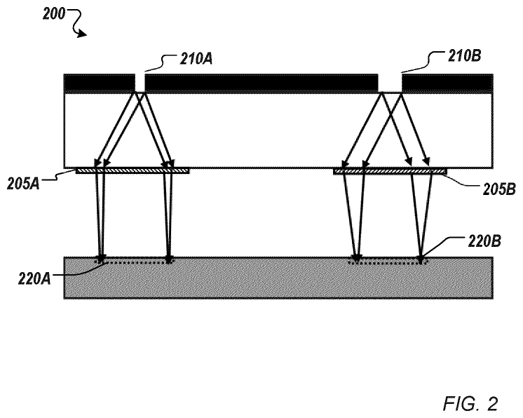

FIG. 2 shows an example of an imaging device 200 (e.g., an array camera) including two imaging components such as metalenses 205A and 205B that can direct light to light-sensitive portions 220A, 220B of an imaging sensor to capture respective images. Imaging components 105A and 105B can have different optical features. In the example of FIG. 2, the imaging components of lenses 205A and 205B have different f-number. For example, a difference in the f-number of lenses 205A and 205B can be higher than a predetermined threshold. For example, apertures 210A and 210B can be selected such that one of the lenses produces a sharper image than the other. For example, one imaging component with very low f-number can be used (e.g., around 1.0) in order to have high change in blur for large object distance (e.g., at least up to 0.5 m). The other imaging component can have a much higher f-number (e.g., ~1.5-2.5). For example, 3D information (e.g., depth) can be extracted by an image processing system as the image processing system shown in FIG. 1 from the fact that objects at different distance from a lens have different amounts of blur. A comparison measure based on an amount of blur in images captured with lenses 205A and 205B can be used to extract the 3D information. Additionally or alternatively, the disparity (e.g., angular disparity) caused by the different locations of lenses 205A and 205B can also be used by an image processing system to extract 3D information. In some examples, additional imaging components with respective additional lenses having an f-number covering the region between the lowest f-number and the highest f-number can be added in order to improve the depth map.

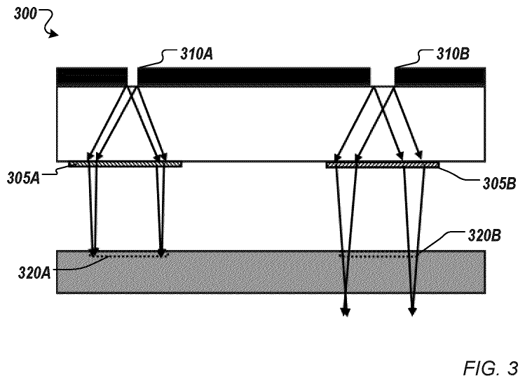

FIG. 3 shows an example of an imaging device 300 (e.g., an array camera) including two imaging components such as metalenses 305A and 305B that can direct light to light-sensitive portions 220A, 220B of an imaging sensor to capture respective images. In the example of FIG. 3, lenses 305A and 305B have different focal lengths. Further, apertures 310A and 310B are selected such that one of the lenses produces a sharper image than the other. The resulting differences optical feature enable the extraction of 2D and 3D information. For example, 3D information can be extracted by an image processing system such as the image processing system shown in FIG. 1 from the fact that objects at different distance from a lens have different amounts of blur. A comparison measure based on an amount of blur in images captured with lenses 205A and 205B can be used to extract the 3D information. Additionally or alternatively, the disparity (e.g., angular disparity) caused by the different locations of lenses 205A and 205B can also be used to extract 3D information.

In some examples, additional imaging components with respective additional lenses having focal lengths between the lowest focal length and the highest focal length of the array camera and/or f-number covering the region between the lowest f-number and the highest f-number can be added in order to improve the depth map.

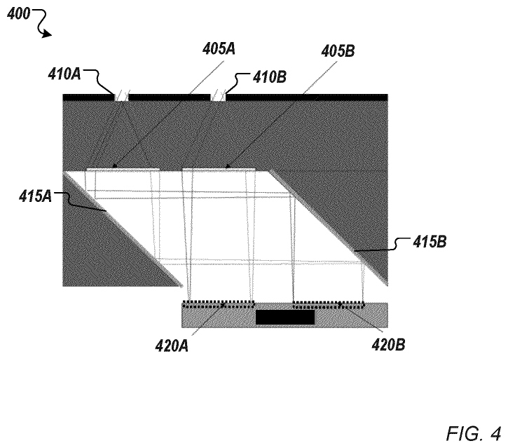

FIG. 4 shows an example of an imaging device 400 (e.g., an array camera) that incorporates folded optics and that is operable to generate an image of a scene and to extract 3D information from the scene. In a camera module, the optical Z height refers to a distance from an optically active surface of an image sensor to an outermost point of a lens. This distance sometimes is referred to as the total track length (TTL). It sometimes is desirable to reduce the optical Z height or the TTL so as to achieve low-height camera modules, which can facilitate integrating the camera modules into compact electronic or other devices. As many applications require a low TTL, the array camera can be combined with folded optics to maintain a low TTL. Imaging device 400 includes two imaging components such as metalenses 405A and 405B with respective apertures 410A, 410B that can direct light to light-sensitive portions 420A, 420B of an imaging sensor to capture respective images. Further, mirrors 415A and 415B can used to reduce the TTL. Similarly to the imaging devices of FIGS. 1-3, information can be extracted by an image processing system such as the image processing system shown in FIG. 1 from the fact that objects at different distance from a lens have different amounts of blur. A comparison measure based on an amount of blur in images captured with lenses 405A and 405B can be used to extract the 3D information. Additionally or alternatively, the disparity (e.g., angular disparity) caused by the different locations of lenses 405A and 405B can also be used to extract 3D information.

Additional imaging components with respective additional lenses having focal lengths between the lowest focal length and the highest focal length of the array camera and/or f-number covering the region between the lowest f-number and the highest f-number can be added in order to improve the depth map.

Although the imaging devices shown in FIGS. 1-4 include two lenses, the imaging devices can include a plurality of lenses, e.g., an array camera.

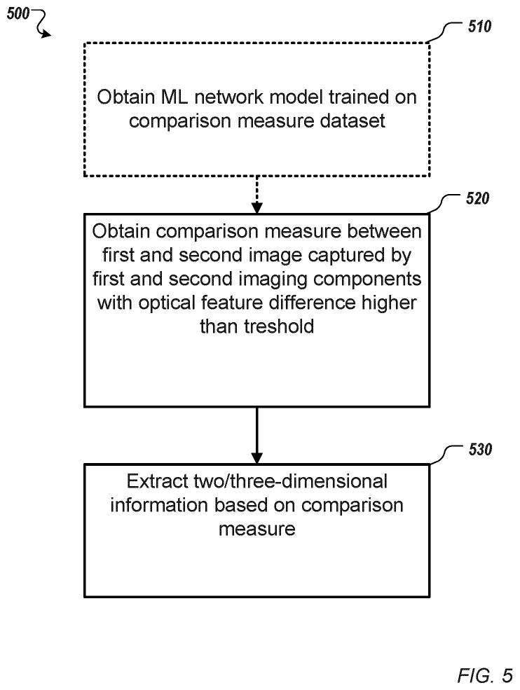

As shown in FIG. 5, in operation, the imaging devices of FIGS. 1-4 can be used to extract 2D and/or 3D information. For example, 3D information can be extracted by an image processing system such as image processing system 160 from the fact that objects at different distance from a lens are captured with different blur amounts in the image. The relationship between distance from the lens and blur amount can be determined from one or more images depicting known distances. Once this relationship is determined, this can be used to infer unknown distances from the blur amounts measured in captured images.

Additionally or alternatively, the disparity (e.g., angular disparity) caused by the different locations of lenses in an array can also be used by imaging processing system 160 to extract 3D information. In some examples, the image processing system 160 can include a trained machine learning network to process comparison measures such as blur and disparity measures to determine three-dimensional information such as depth. In some instances, the image processing system 160 can incorporate artificial intelligence and may include iterative and/or deep learning techniques. (FIG. 5, at 510). The machine learning network can be trained with an image set of known 2D/3D information and known camera parameters that can be associated during training to input blur amounts and/or disparity measures.

Once the trained machine learning network is obtained, comparison measures between first and second images captured by first and second imaging components with different optical feature lengths and/or f-numbers (e.g., a optical feature length and/or f-number difference higher than a threshold) can be obtained at 520. The comparison measures can be blur amount and/or disparity measures.

At 530, the two-dimensional and/or three-dimensional information can be extracted based on the comparison measure(s) such as blur and/or disparity comparison measures. For example, the obtained trained machine learning network can be used to process the comparison measures as input and to obtain corresponding two/three-dimensional information such as depth information.

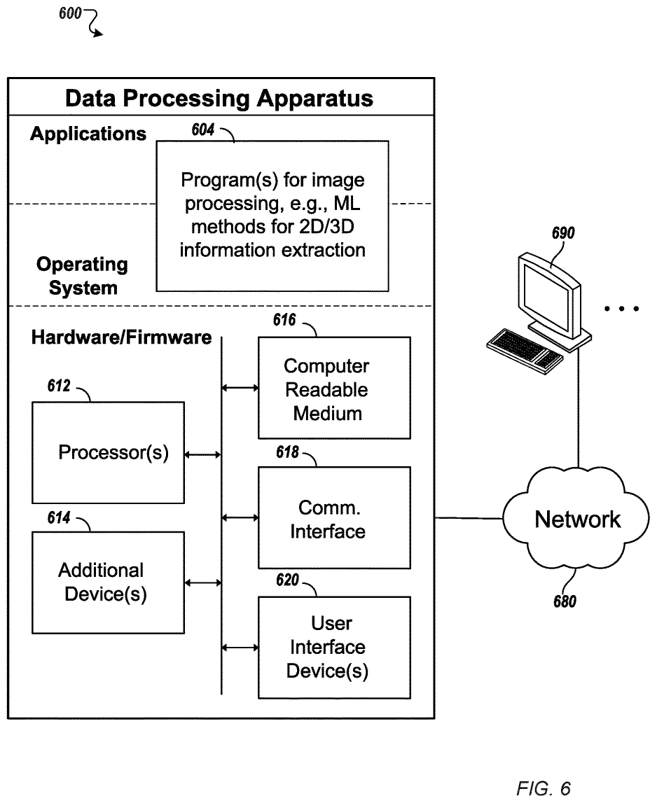

FIG. 6 is a schematic diagram of a data processing system including a data processing apparatus 500, which can be programmed as a client or as a server. The data processing apparatus 500 is connected with one or more computers 690 through a network 680. While only one computer is shown in FIG. 6 as the data processing apparatus 500, multiple computers can be used. The data processing apparatus 500 includes various software modules, which can be distributed between an applications layer and an operating system. These can include executable and/or interpretable software programs or libraries, including tools and services of one or more programs 604 for image processing. The program(s) 604 can implement one or more machine learning methods for 2D/3D information extraction. Further, the program(s) 604 can potentially implement manufacturing control operations of components of imaging devices (e.g., generating and/or applying specifications to effect manufacturing of metaoptical elements for array cameras). The number of software modules used can vary from one implementation to another. Moreover, the software modules can be distributed on one or more data processing apparatus connected by one or more computer networks or other suitable communication networks.

The data processing apparatus 500 also includes hardware or firmware devices including one or more processors 612, one or more additional devices 614, a computer readable medium 616, a communication interface 618, and one or more user interface devices 620. Each processor 612 is capable of processing instructions for execution within the data processing apparatus 500. In some implementations, the processor 612 is a single or multi-threaded processor. Each processor 612 is capable of processing instructions stored on the computer readable medium 616 or on a storage device such as one of the additional devices 614. The data processing apparatus 500 uses the communication interface 620 to communicate with one or more computers 690, for example, over the network 680. Examples of user interface devices 620 include a display, a camera, a speaker, a microphone, a tactile feedback device, a keyboard, a mouse, and VR and/or AR equipment. The data processing apparatus 500 can store instructions that implement operations associated with the program(s) described above, for example, on the computer readable medium 616 or one or more additional devices 614, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, e.g., after delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magnetooptical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magnetooptical disks; and CDROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a browser user interface through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In addition, actions recited in the claims can be performed in a different order and still achieve desirable results.

1. An imaging device comprising:
a sensor comprising a first light sensitive region and a second light sensitive region plurality; and
a first imaging component and a second imaging component, wherein the first and the second imaging components are configured to direct light to the first light sensitive region and the second light sensitive region, respectively, to capture respective first and second images of a scene for extracting three-dimensional information of the scene,
wherein the first imaging component has a first value of an optical parameter and the second imaging component has a second value of the optical parameter,
wherein the first value is different from the second value, and
wherein a difference between the first value and the second value is configured to enable extraction of the three-dimensional information of the scene predetermined threshold.

2. The imaging device of claim 1 wherein the first value comprises a first f-number of the first imaging component and the second value comprises a second f-number of the second imaging component, wherein a difference between the first and second f-numbers is configured to enable the extraction of the three-dimensional information of the scene.

3. The imaging device of claim 1, wherein the first value comprises a first focal length and the second value comprises a second focal length, wherein a difference between the first and second focal lengths is configured to enable the extraction of the three-dimensional information of the scene.

4. The imaging device of claim 1, comprising:
an image processor configured to:
receive signals representing the first and second images captured by the first and second light sensitive regions, and
extract the three-dimensional information of the scene based on the difference between the first value and the second value of the optical parameter.

5. A method performed by an image processor, the method comprising:
obtaining a comparison measure indicating a difference between a first image and a second image of a scene,
wherein the first image is captured by a first imaging component and the second image is captured by a second imaging component, wherein the first imaging component has a first value of an optical parameter and the second imaging component has a second value of the optical parameter,
wherein a difference between the first value and the second value configured to cause the difference between the first image and the second image; and
extracting three-dimensional information of the scene based on the comparison measure.

6. The method of claim 5, wherein the comparison measure indicates a difference in a blur amount between the first image and the second image, and
wherein extracting the three-dimensional information of the scene is based on the difference in blur amount.

7. The method of claim 5, wherein the three-dimensional information is extracted by a machine learning network trained to extract the three-dimensional information.

8. The method of claim 7, wherein the machine learning network is trained based on an image set having known two-dimensional and three-dimensional information and known corresponding camera parameters.

9. The imaging device of claim 1, wherein a focal length of the first imaging component matches a distance between the first imaging component and the first light sensitive region, and
wherein a focal length of the second imaging component does not match a distance between the second imaging component and the second light sensitive region.

10. The imaging device of claim 1, wherein the first value of the optical parameter and the second value of the optical parameter are configured such that an amount of blur in the first image is different from an amount of blur in the second image.

11. The imaging device of claim 1, wherein the first imaging component comprises a first lens and the second imaging component comprises a second lens.

12. The imaging device of claim 11, wherein the first imaging component comprises a first aperture for providing light to the first lens, and wherein the second imaging component comprises a second aperture for providing light to the second lens.

13. The imaging device of claim 2, wherein the first f-number is about 1.0, and wherein the second f-number is in a range from 1.5 to 2.5.

14. The imaging device of claim 4, wherein the image processor is configured to extract the three-dimensional information based on a difference in amount of blur between the first image and the second image.

15. The imaging device of claim 14, wherein the image processor is configured to extract the three-dimensional information based on (i) the difference in the amount of blur and (ii) a relationship between a distance from the sensor and a blur level.

16. The method of claim 6, wherein the optical parameter comprises a focal length, and
wherein a difference in the focal length between the first imaging component and the second imaging component is configured to cause the difference in blur amount.

17. The method of claim 6, wherein the optical parameter comprises an f-number, and
wherein a difference in the f-number between the first imaging component and the second imaging component is configured to cause the difference in blur amount.

18. The method of claim 17, wherein an f-number of the first imaging component is about 1.0, and wherein an f-number of the second imaging component is in a range from 1.5 to 2.5.

19. The method of claim 5, wherein the comparison measure comprises a disparity measure, and
wherein extracting the three-dimensional information of the scene is based on the disparity measure.

20. The imaging device of claim 1, wherein the first imaging component comprises a first lens and the second imaging component comprises a second lens.
